(19) United States
(12) Patent Application Publication
(10) Pub. No.: US 2006/0013332 A1
(43) Pub. Date: Jan. 19, 2006

(54) Method of sending information using superresolution to didtinguish overlapping symbols

(76) Inventor: David Courtney Rayburn, Indian Herbour Beach, FL (US)

Correspondence Address: David Rayburn, 1030 Pine Tree Drive #2, Indian Harbour Beach, FL, 32937, US

(21) Appl. No.: 10/893,687

(22) Filed: Jul. 16, 2004

(51) Int. Cl. H04L 27/04

(52) U.S. Cl. 375/295

(57) ABSTRACT

The invention is a method of sending information through a bandwidth-constrained information channel at a rate faster than the current limit of the state of the art. It accomplishes this objective by sending overlapping signals which are separated using superresolution methods such as deconvolution to distinguish between symbols which are overlapping. This method is capable of sending information through a bandwidth-constrained information channel substantially faster than the Shannon-Nyquist limit, which is the limit of the current state of the art. The method is composed of convolving the input data with a kernel; sending the result of the convolution as a signal through a communication system; deconvolving said signal with respect to the kernel; and outputting the results of said deconvolution through a means of information output.

### REFERENCES

This application claims priority by provisional patent application No. 60/489,598 and incorporates it by reference herein.

### REFERENCES CITED

US Patent Documents:

| | | |
|---|---|---|
| 5,122,732 | Jun. 16, 1992 | Engeler, et al. |
| 5,168,214 | Dec. 1, 1992 | Engeler, et al. |
| 5,686,922 | Nov. 11, 1997 | Stankwitz, et al. |
| 5,748,507 | May 5, 1998 | Abatzoglou, et al. |
| 5,784,492 | Jul. 21, 1998 | Cohen, et al. |
| 6,483,952 | Nov. 19, 2002 | Gregory, et al. |

### OTHER REFERENCES

1) Shannon, C. E., “A Mathematical Method of Communication”, Reprinted from The Bell System Technical Journal, Vol. 27, July, October 1948, pp 379-423, 623-656.
2) Rodney G. Vaughan and Neil L. Scott, “Super-Resolution of Pulsed Multipath Channels for Delay Spread Characterization”, IEEE Transactions on Communications vol. 47, no. 3, March 1999, pp. 343-347
3)Angelos D. Liveris and Costas N. Georghiades, “Exploiting faster-than-Nyquist signaling”, IEEE Transactions on Communications vol. 51, no. 9, September 2003, pp. 1502-1511
4) R. A. Zakarevicius and K. Feher, “On the Speed Tolerance of Certain Classes of Data Transmission Systems”, IEEE Transactions on Communications vol. 34, no. 8, August 1986, pp. 832-836
5) Cheng-Kun Wang and Lin-Shan Lee, “Practically Realizable Digital Transmission Significantly Below the Nyquist Bandwidth”, IEEE Transactions on Communications vol. 43, no. 2/3/4, February/March/April 1995, pp. 166-169
6) Ender Ayanoglu, “Data transmission when the sampling frequency exceeds the Nyquist rate”, IEEE Communications Letters vol. 1, no. 6, November 1997, pp. 157-159
7) J. E. Mazo and H. J. Landau, “On the Minimum Distance Problem for Faster-than-Nyquist Signaling”, IEEE Trans. Inf Theory, vol. 34, no. 6 November 1989, pp. 1420-1427.
8) H. J. Landau, “Sampling, Data Transmission, and the Nyquist Rate”, Proc. IEEE, vol. 55 Oct. 1967, pp. 1701-1706.

### BACKGROUND OF THE INVENTION

1. Field of the Invention

This invention relates generally to methods used for sending information through an information channel at a high rate of transmission and reception with a minimum amount of error.

2. Background

Current methods of sending information through a channel which is bandwidth-limited are limited to a maximum error-free rate or channel capacity of C=W*log₂(SN+1), where C is the channel capacity, W is the bandwidth, and SN is the signal to noise ratio. Equivalently, for a system with discrete amplitude levels, C=W*log₂(N), where N is the number of available amplitude levels. The actual error-free transmission rate is of course smaller for discrete systems with noise. For more information see Shannon, C. E., “A Mathematical Method of Communication”, Reprinted from The Bell System Technical Journal, Vol. 27, July, October 1948, pp 379-423, 623-656. None of the modulation methods developed since the time of Shannon's landmark paper have superceded by more than a few percent the limits placed upon channel capacity presented in the paper mentioned above. This invention supercedes the limits derived in said referenced paper by the simple expedient of sending overlapping symbols or pulses, which are then separated at the receiving end by deconvolution or an equivalent mathematical method. Shannon's derivation of the channel capacity makes the assumption that overlapping symbols or pulses are inseparable, a constraint which is obeyed by the current state of the art.

Previous applications of superresolution methods have been used to increase the amount of information discerned from an information source, but have not been directly applied to increase the transmission capacity of a communications channel. Engeler, et al. in U.S. Pat. Nos. 5,122,732 and 5,168,214 disclose application of superresolution methods to better determine the temporal spectrum of a signal, but did not use this to increase the information capacity or rate of the system. Stankwitz, et al. in U.S. Pat. No. 5,686,922 disclose a superresolution method to resolve beyond diffraction limits in radar. Abatzoglou, et al. in U.S. Pat. No. 5,748,507 disclose a method of using superresolution methods to improve resolution of frequency components of a signal. Cohen, et al. in U.S. Pat. No. 5,784,492 disclose use of a superresolution technique (the CLEAN algorithm) to compress a redundant data set. This method as presented applies to data compression and does not generate any gain in system transmission rate for non-redundant information. Gregory, et al. in U.S. Pat. No. 6,483,952 disclose a method for extracting additional information from an optical sensor system using superresolution methods, particularly with respect to spatial resolution information. Vaughan et. al., “Super-Resolution of Pulsed Multipath Channels for Delay Spread Characterization.” in IEEE Transactions on Communications vol. 47, no. 3, March 1999, pp. 343-347, utilizes superresolution methods to determine the effects of multipath propagation upon a signal.

Investigations of sending signals faster than Nyquist have been made, but none so far have utilized superresolution methods to cope with intersymbol interference. Landau in “Sampling, Data Transmission, and the Nyquist Rate” IEEE Proc. vol. 55, October 1967, pp. 1701-1706 performed calculations showing that for arbitrary signals, transmission beyond the Nyquist rate resulted in unstable measured signals. Later, in “On the Minimum Distance Problem for Faster-than-Nyquist Signaling”, IEEE Trans. Inf. Theory, vol. 34, no. 6 November 1989, pp. 1420-1427, Landau and Mazo calculate the amount of intersymbol interference generated when binary valued signals are sent with very close spacing. Liveris et al. in “Exploiting faster-than-Nyquist signaling” IEEE Transactions on Communications vol. 51, no. 9, September 2003, pp. 1502-1511 also discuss the effect of intersymbol interference upon faster-than-Nyquist signaling, but do not discuss use of superresolution methods to deal with its effects. Zakarevicius et al. in “On the Speed Tolerance of Certain Classes of Data Transmission Systems” IEEE Transactions on Communications vol. 34, no. 8, August 1986, pp. 832-836 also analyze the effect of intersymbol interference upon faster-than-Nyquist signaling, but do not discuss the use of superresolution. Wang et al., in “Practically Realizable Digital Transmission Significantly Below the Nyquist Bandwidth” IEEE Transactions on Communications vol. 43, no. 2/3/4, February/March/April 1995, pp. 166-169, use digital pulses to transmit with a permissible amount of intersymbol interference, but do not use superresolution methods to detect the relative location of their digital pulses. All of the above methods of faster-than-Nyquist transmission rely upon establishing a maximum permissible level of intersymbol interference, which is less than an amount which can be reliably detected using standard means of pulse detection. This is different from the use of superresolution methods in that any amount of intersymbol interference can be removed by discernment with superresolution methods, subject to the constraints of resolution and noise.

### BRIEF SUMMARY OF THE INVENTION

The invention teaches a method of sending information through a bandwidth-constrained information channel, such as a band-limited radio spectrum, at an error-free rate substantially faster than the Shannon-Nyquist limit. It accomplishes this objective by sending overlapping signals which are separated using superresolution methods such as deconvolution to distinguish between symbols which are overlapping. By determining the presence of the symbols in the presence of intersymbol interference, more symbols can be sent per unit time, increasing the data transmission rate.

### DETAILED DESCRIPTION OF THE INVENTION

A method of information transmission, or signal modulation, whereby symbols are discerned in the presence of intersymbol interference by means of deconvolution with respect to a known kernel, or by means of other superresolution methods. In the preferred embodiment, a known kernel, also known as a base pulse, is determined upon, either mathematically using the known characteristics of the channel, or experimentally by testing the response of the channel to a test pulse or chirp. The knowledge of the parameters of the base pulse must be known to both the sender and receiver. The information to be transferred is represented in binary data format. The base pulse is created such that it has a time sampling rate of W*N, where W is the bandwidth of the system, and N is the number of available amplitude levels, and a bandwidth small enough that the base pulse can be transmitted through the channel without appreciable distortion. The bandwidth restriction in general will require the duration of the base pulse to be at least W/2 samples. The signal to be sent is the convolution of the base pulse with the binary data. This is equivalent to adding the base pulse to the signal if a data bit is one, and not adding the base pulse to the signal if the data bit is zero, then incrementing the signal by one sample and the data by one bit, and repeating the addition process until all the data has been incremented through. A number of zeros may be appended to the data to facilitate transmission of the tail end of the signal, which consists of a portion of the last few base pulses added to the signal.

A reverse method is used for interpreting the received data. The signal is deconvolved with respect to the known base pulse. The entire signal can be received prior to deconvolution, or one of a variety of methods familiar to one practiced in the art can be used to deconvolve the signal in portions. In order to keep errors to a minimum, filtering of the signal to the frequency bands of the channel should be performed before deconvolution, as well as rounding of the result of the deconvolution to the nearest binary (one or zero) value. Additional error checking methods such as checking hash values may be applied.

When rounding of the result of the filtered deconvolution is applied, mean noise amplitude of greater than half the mean amplitude of the base pulse must occur during the time period that a base pulse is the additive part of the signal in order for an error to be registered in the received data.

In addition to sending the signal generated through the bandwidth-constrained channel, the signal can also be used to modulate another signal, so that the resultant signal fits within the bandwidth constraints without distortion. This can be used, for example, to modify a sound signal to fit within a narrower bandwidth, which is then used to modulate an FM signal. As the bandwidth of the FM signal is a function of the bandwidth of the signal used to modulate it, this thereby reduces the bandwidth of the FM signal. It should be noted that the modulated signal should either have a sample rate high enough that overlapping signals can be distinguished, or be analog in nature.

### ALTERNATE EMBODIMENTS

As above, with a different sample rate applied.

As above, wherein more than one kind of possible base pulse is sent, and separation and determination of the kind of base pulse conveys information.

As above, wherein the data to be sent is in other than binary data format. In this case the rounding step would round to the nearest data point which lies within the format used.

As above, wherein the filtering or error checking steps are omitted.

As above, wherein the deconvolution is applied by mathematically equivalent means.

As above, wherein using the signal to modulate another signal and thereby reduce its bandwidth is contained in the same device or process.

As above, wherein the ability to separate overlapping pulses accomplished by use of a superresolution method is used to facilitate an increase in range or reduction in power needed for transmission.

As above, wherein the base pulse is a wavelet.

Other embodiments are possible without departing from the essential characteristics of the invention. For example, non-essential but helpful steps such as rounding or filtering may be omitted, or the deconvolution may be accomplished by equivalent means.

From the above description, it will be apparent that the invention disclosed herein provides a novel and advantageous method of reducing the bandwidth requirements for a particular information transmission rate. The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

What is claimed is:

1. A method of transmitting information at a rate faster than the Shannon-Nyquist limit through a bandwidth-limited channel, using an apparatus comprised of:
a means of information input;
a kernel, or equivalently a base pulse, which is a signal which is capable of passing through the bandwidth constraint of the channel without significant distortion;
a communication system with a bandwidth constraint;
a means of convolving the kernel with the incoming data stream and then sending the product of said convolution through the aforementioned communication system;
a means of deconvolving the data received from the communication system with respect to the kernel, and sending the product of said deconvolution to the information output of the system;
a means of information output (such as a recording, transmission, or display mechanism);
wherein the steps of said method are comprised of:
convolving the input data with the kernel;
sending the result of the convolution as a signal through the communication system, performing any modulation, equalization, and normalization which would normally be performed on a signal passing through said communication system;
deconvolving said signal with respect to the kernel;
outputting the results of said deconvolution through the means of information output.

2. A method as recited in claim 1, wherein the deconvolution step is aided by error correction means such as filtering, rounding or checkbits.

3. A method as recited in claim 1, wherein the communication system is comprised of a radio communication system.

4. A method as recited in claim 1, wherein the kernel is found by means of testing the bandwidth response and/or signal to noise ratio of the communication system.

5. A method as recited in claim 1, wherein the kernel is updated on a continuous or intermittent basis by continuously or repetitively testing the bandwidth response and/or signal to noise ratio of the communication system.

6. A method as recited in claim 1, wherein the means of convolution and deconvolution are digital processors.

7. A method as recited in claim 1, wherein the information which is input to the apparatus is represented as binary digits.

8. A method as recited in claim 1, wherein the kernel is a wavelet.

9. A method as recited in claim 1, wherein superresolution methods other than deconvolution with respect to a known kernel are used to distinguish overlapping signals.

10. A method as recited in claim 1, wherein the signal generated by the method is used to modulate another signal which is contained in the same device or process.

11. A method as recited in claim 1, wherein the bandwidth reduction enabled by the ability to separate overlapping pulses accomplished by use of a superresolution method is used to facilitate an increase in range or reduction in power needed for transmission.

12. A method of transmitting information at a rate faster than the Shannon-Nyquist limit, but at a rate equal to or less than (N+1)/log2(N+1) times the Shannon-Nyquist limit, where N is the Signal-to-Noise ratio through a bandwidth-limited channel.
